(19) United States
(12) Patent Application Publication
(10) Pub. No.: US 2005/0101685 A1
(43) Pub. Date: May 12, 2005

(54) UV curable composition for forming dielectric coatings and related method

(75) Inventor: Roy C. Krohn, Kimball, MI (US)

Correspondence Address: BROOKS KUSHMAN P.C., 1000 TOWN CENTER, TWENTY-SECOND FLOOR, SOUTHFIELD, MI, 48075, US

(73) Assignee: Allied PhotoChemical, Inc., Kimball, MI (US)

(21) Appl. No.: 10/703,938

(22) Filed: Nov. 7, 2003

(51) Int. Cl. C08G 2/00

(52) U.S. Cl. 522/71

(57) ABSTRACT

The present invention discloses a photocurable composition for forming a dielectric layer on a substrate. The dielectric composition of the present invention comprises a first acrylated oligomer, a second acrylated oligomer having a viscosity less than the first acrylated oligomer, a polyolefin wax, an acrylated monomer and a photoinitiator. The first acrylated oligomer as used in the composition of the invention has a viscosity that is less than the second acrylated oligomer. The present invention also discloses a method of making a dielectric coating using the composition of the present invention.

### BACKGROUND OF THE INVENTION

1. Field of the Invention

The present invention relates to photocurable compositions that when applied to a substrate and cured form a dielectric coating on the substrate.

2. Background Art

Dielectric coatings and thin films are utilized in a multitude of electric and microelectronic applications. Such applications include dielectric layers in semiconductors, passivating layers, coatings that surround electrical wires, the dielectric layer in capacitors, electrically insulating layers between metallic gridlines, and the like. Moreover, dielectric coatings and layers may be made from such diverse processes which include both low pressure and atmospheric pressure deposition processes.

The low pressure deposition processes include sputtering, low pressure chemical vapor deposition, plasma deposition, and the like. Such low pressure deposition processes typically require expensive equipment. These processes are most important for the precision coating of substrates such as those used in the microelectronics industry.

Atmospheric pressure processes for forming dielectrics include such process as atmospheric chemical vapor deposition, spray coating, dip coating, screen printing, and the like. This processes tend to require less expensive equipment and are more suitable for less precision requiring applications. Methods such as spray coating, dip coating, and screen printing utilize liquid compositions that are applied to a substrate and then thermally treated to form the dielectric layer. Such thermally curable compositions typically contain organic solvents that contain a significant amount of volatile organic compounds (VOCs). These VOCs escape into the atmosphere while the heat curable coating dries. Such solvent based systems are undesirable because of the hazards and expenses associated with VOCs. The hazards include water and air pollution and the expenses include the cost of complying with strict government regulation on solvent emission levels.

Accordingly, there exists a need to provide environmentally safe UV curable dielectric compositions which exhibit improved performance and workability. Additionally, there is a need to provide a method of such compositions to a substrate to form a dielectric coating.

### SUMMARY OF THE INVENTION

The present invention overcomes the problems of the prior art by providing in one embodiment a photocurable composition for forming a dielectric layer on a substrate (“the dielectric composition”). The dielectric composition of the present invention comprises a first acrylated oligomer, a second acrylated oligomer having a viscosity less than the first acrylated oligomer, a wax, an acrylated monomer and a photo initiator.

In another embodiment, the present invention provides a method of forming a dielectric coating using the composition of the invention. The method of this embodiment comprises applying the dielectric composition to a substrate followed by curing with actinic radiation for a sufficient time to form the dielectric coating.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventor.

The term “polymer” as used herein refers to a molecule of relatively high molecular mass made up by the repetition of a simpler molecule of low relative molecular mass.

The term “degree of polymerization” as used herein refers to the number of repeating simpler molecules.

The term “oligomer” as used herein refers to a molecule of intermediate molecular mass. Oligomers often comprise a small plurality of lower molecular mass molecule. Moreover, oligomers will typically have a degree of polymerization from 2 to 20.

The term “polyurethane” are used herein refers to polymers containing urethane groups (—NH—CO—O—) typically created by reacting isocyanates with polyols and chain extenders.

The term “aliphatic” as used herein refers to nonaromatic saturated or unsaturated linear or branched hydrocarbon group which includes for example alkyl, alkenyl, and alkynyl groups.

The term “acrylated” as used herein refers to monoacrylated, monomethacrylated, multi-acrylated, and multi-methacrylated monomers, oligomers and polymers.

The term “acrylic” refers to thermoplastic resins or oligomers made by polymerizing acrylic or methacrylic acid or a derivative of thereof.

The term “wax” as used herein refers to a solid or semisolid substance made of hydrocarbons. Examples include, polyolefin waxes such as polyethylene waxes, polypropylene waxes, and the like.

The term “micronized” as used herein refers to a material which is in a powder form. Typically, such powders have particle sizes on the order one or several microns.

In one embodiment of the present invention, a presently preferred photocurable composition for forming a dielectric layer on a substrate (“the dielectric composition”) is provided. The dielectric composition of the present invention comprises a first acrylated oligomer, a second acrylated oligomer having a viscosity less than the first acrylated oligomer, a wax, an acrylated monomer and a photo initiator. The dielectric compositions of the invention are typically fluid phase compositions containing less than about 10 weight percent volatile organic compounds (“VOCs”). More preferably, the dielectric compositions contain less than about 5 weight percent VOCs; and most preferably, the dielectric compositions contain less than about 1% VOCs. The viscosity of the dielectric composition of the present invention is preferably from about 3000 cP (centipoise) to about 8000 cP at 25° C. (as measured by the Brookfield method at 1.0 mil). More preferably, the viscosity of the dielectric composition is from about 4000 cP to about 700 cP at 25° C.; and most preferably, the viscosity of the dielectric composition of the present invention is from about 4500 cP to about 6500 cP at 25° C.

The dielectric composition of the present invention includes a first acrylated oligomer that selected from the group consisting of acrylated epoxy oligomers, acrylated polyester oligomers, acrylated silicone oligomers, acrylated acrylic oligomers, acrylated urethane oligomers, acrylated melamine oligomers, and mixtures thereof. Preferably, the first acrylated oligomer comprises aliphatic urethane acrylate. Suitable aliphatic urethane acrylate include, but are not limited to, aliphatic urethane monoacrylates, aliphatic urethane diacrylates, aliphatic urethane triacrylates, and mixtures thereof. Moreover, the first acrylated oligomer is further characterized by having a viscosity greater than the second acrylated oligomer.

The first acrylated oligomer is preferably present in an amount of about 5% to 80% of the total weight of the dielectric composition. The first acrylated oligomer is more preferably present in an amount of about 10% to 50% of the total weight of the dielectric composition, and most preferably about 30% of the total weight of the dielectric composition. The first acrylated oligomer preferably comprises one or more aliphatic urethane acrylates. Suitable aliphatic urethane acrylates include Radcure Ebecryl 244 (aliphatic urethane diacrylate diluted 10% by weight with 1,6-hexanediol diacrylate), Ebecryl 264 (aliphatic urethane triacrylate diluted 15% by weight with 1,6-hexanediol diacrylate), Ebecryl 284 (aliphatic urethane diacrylate diluted 12% by weight with 1,6-hexanediol diacrylate) urethanes, commercially available from Radcure UCB Corp. of Smyrna, Ga.; Sartomer CN-961E75 (aliphatic urethane diacrylate blended with 25% by weight ethoxylated trimethylol propane triacylate), CN-961H81 (aliphatic urethane diacrylate blended with 19% by weight 2(2-ethoxyethoxy)ethyl acrylate), CN-963A80 (aliphatic urethane diacrylate blended with 20% by weight tripropylene glycol diacrylate), CN-964 (aliphatic urethane diacrylate), CN-966A80 (aliphatic urethane diacrylate blended with 20% by weight tripropylene glycol diacrylate), CN-982A75 (aliphatic urethane diacrylate blended with 25% by weight tripropylene glycol diacrylate) and CN-983 (aliphatic urethane diacrylate), commercially available from Sartomer Corp. of Exton, Pa.; TAB FAIRAD 8010, 8179, 8205, 8210, 8216, 8264, M-E-15, UVU-316, commercially available from TAB Chemicals of Chicago, Ill.; and Echo Resin ALU-303, commercially available from Echo Resins of Versaille, Mo.; and Genomer 4652, commercially available from Rahn Radiation Curing of Aurora, Ill. Ebecryl 264 is an aliphatic urethane triacrylate of 1200 molecular weight supplied as an 85% solution in hexanediol diacrylate. Ebecryl 284 is aliphatic urethane diacrylate of 1200 molecular weight diluted 10% with 1,6-hexanediol diacrylate. Combinations of these materials may also be employed herein. The preferred aliphatic urethane is Ebecryl 244.

The dielectric composition of the present invention also includes a second acrylated oligomer that has a lower viscosity than the first acrylated oligomer. Suitable second acrylated oligomers include for example, acrylated epoxy oligomers, acrylated polyester oligomers, acrylated silicone oligomers, acrylated acrylic oligomers, acrylated urethane oligomers, acrylated melamine oligomers, and mixtures thereof. The second acrylated oligomer will typically comprise a component selected from the group consisting of aliphatic monoacrylates oligomers, aliphatic diacrylate oligomesr, an aliphatic triacrylate oligomers, and mixtures thereof. Preferably, the second acrylated oligomer comprises an aliphatic urethane acrylate. Suitable aliphatic urethane acrylate include, but are not limited to, aliphatic urethane monoacrylates, aliphatic urethane diacrylates, aliphatic urethane triacrylates, and mixtures thereof. As set forth above, the viscosity of the second acrylated oligomer is less than the first second acrylated oligomer. Typically, the second acrylated oligomer has a viscosity less than about 3000 cP at 25° C. Preferably, the second acrylated oligomer is less than about 2000 cP at 25° C. More preferably, the second acrylated oligomer has a viscosity less than about 1500 cP at 25° C.; and most preferably, the second acrylated oligomer has a viscosity less than about 1000 cP at 25° C. A suitable second acrylated monomer is CN132 (a proprietary low viscosity aliphatic urethane diacrylate oligomer) commercially available from Sartomer Corporation. A suitable example of the second acrylated oligomer is CN132 which is commercially available from Sartomer Corp. located in Exton, Pa.

Preferably, the second acrylated oligomer is present in an amount from about 1% to about 30% of the total weight of the dielectric composition. More preferably, the second acrylated oligomer 1% to about 15% of the total weight of the dielectric composition; and most preferably, the second acrylated oligomer is present from about 5% of the total weight of the dielectric composition. Preferably, the viscosity of the second acrylate is less than about 2000 cP at 25° C. More preferably, the viscosity of the second acrylate is less than about 1500 cP at 25° C.; and most preferably, the viscosity of the second acrylate is less than about 1000 cP at 25° C.

The dielectric composition of the present invention also includes an acrylated monomer. The acrylated monomer is preferably present in an amount from about 5% to about 80% of the total weight of the dielectric composition. More preferably, the acrylated monomer is present in an amount from about 10% to about 60% of the total weight of the dielectric composition; and most preferably, the acrylated monomer is present in an amount of about 35% of the total weight of the dielectric composition. A particularly preferred acrylated monomer is an ethylenically unsaturated monomer having Formula I: 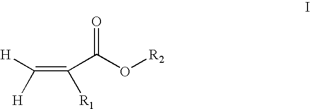
wherein R₁ is hydrogen or substituted or unsubstituted alkyl; and R₂ is substituted or unsubstituted alkyl having more than 4 carbon atoms, cycloalkyl, cycloalkenyl, or substituted or unsubstituted aryl. Preferably R₁ is hydrogen or methyl; and R₂ is isoborynl, phenyl, benzyl, dicylcopentenyl, dicyclopentenyl oxyethyl, ethylene glycol dicyclopentyl ether, cyclohexyl, and naphthyl. A particularly useful monomer is a mixture of an isobornyl acrylate monomer (i.e., R₂ is isobornyl) and ethylene glycol dicyclopentyl ether acrylate. Ethylene glycol dicyclopentyl ether acrylate is commercially available from Sigma-Aldrich located in Milwaukee, Wis. A suitable isobornyl acrylate monomer is Sartomer SR-423 (isobornyl methacrylate):

The dielectric composition of the present invention also includes a co-initiator. Preferably the co-initiator is an amine functional acrylate co-initiator. The co-initiator is preferably present in an amount from about from about 1% to about 10% of the total weight of the dielectric composition. More preferably, the co-initiator is present in an amount from about 1% to about 6% of the total weight of the dielectric composition; and most preferably the co-initiator is present an amount of about 4% of the total weight of the dielectric composition. A suitable co-initiator is Ebecryl 7100 (an amine functional acrylate co-initiator) commercially available form UCB Chemicals.

The dielectric composition of the present invention also includes a wax. Preferably, the wax is present in an amount from about 1% to about 60% of the total weight of the dielectric composition. More preferably, the wax is present in an amount from about 1% to about 40% of the total weight of the dielectric composition; and most preferably, the wax is present in an amount from about 1% to about 30% of the total weight of the dielectric composition. Particularly waxes are micronized waxes. Suitable waxes include, for example, polyolefin waxes such as polyethylene waxes, polypropylene waxes and mixtures thereof. Examples of waxes that may be used in the practice of the invention are MPP-230F, MPP-620F, MPP-230VF, MPP-620VF, MPP-230XF, MPP-620XF, MPP-308F, MPP-620XXF MPP-308VF, MPP-480F, MPP-635G, MPP-480VF, MPP-635F, MPP-550, MPP-635VF, MPP-611, MPP-635XF, MPP-611XF, and MPP-123 commercially available from Micropowders, Inc. located in Tarrytown, N.Y.

The dielectric composition of this embodiment also includes a photoinitiator in an amount of about 0.1% to 15% of the total weight of the dielectric composition of the dielectric composition. The photoinitiator is more preferably present in an amount of about 1% to 10% of the total weight of the dielectric composition; and most preferably about 3% of the total weight of the dielectric composition. Suitable photoinitiators include Irgacure 184 (1-hydroxycyclohexyl phenyl ketone), Irgacure 907 (2-methyl-1-[4-(methylthio)phenyl]-2-morpholino propan-1-one), Irgacure 369 (2-benzyl-2-N,N-dimethylamino-1-(4-morpholinophenyl)-1-butanone), Irgacure 500 (the combination of 50% by weight 1-hydroxy cyclohexyl phenyl ketone and 50% by weight benzophenone), Irgacure 651 (2,2-dimethoxy-2-phenyl acetophenone), Irgacure 1700 (the combination of 25% by weight bis(2,6-dimethoxybenzoyl-2,4-,4-trimethyl pentyl)phosphine oxide, and 75% by weight 2-hydroxy-2-methyl-1-phenyl-propan-1-one), Irgacure 2020 (a blend of BAPO (Irgacure 819) plus an alpha hydroxy ketone), Darocur 1173 (2-hydroxy-2-methyl-lphenyl-1-propane) and Darocur 4265 (the combination of 50% by weight 2,4,6-trimethylbenzoyldiphenyl-phosphine oxide, and 50% by weight 2-hydroxy 2-methyl-1-phenyl-propan-1-one), available commercially from Ciba-Geigy Corp., Tarrytown, N.Y.; CYRACURE UVI-6974 (mixed triaryl sulfonium hexafluoroantimonate salts) and CYRACURE UVI-6990 (mixed triaryl sulfonium hexafluorophosphate salts) available commercially from Union Carbide Chemicals and Plastics Co. Inc., Danbury, Conn.; and Genocure CQ, Genocure BOK, and Genocure M.F., commercially available from Rahn Radiation Curing. Combinations of these materials may also be employed herein. The preferred photoinitiator is a mixture of Irgacure 500 and Irgacure 2020.

The dielectric composition of the present invention may also include a talc. In general, talc comprise MgO.4SiO₄.H₂O. It has been surprising found that the addition of talc to the dielectric composition improves the appearance of dielectric coatings made from the dielectric composition. For example, the addition of talc has been observed to make the dielectric coatings made from the dielectric composition appear smoother. Although not limiting this phenomenon to any particular mechanism or theory of operation, it is believed that talc reduces agglomeration of the wax thereby improving the dielectric coating's appearance. Preferably, the talc is present in an amount from about 0% to about 50% of the total weight of the dielectric composition. More preferably, the talc is present in an amount of about 0.1% to about 25% of the total weight of the dielectric composition; and most preferably, the talc is present in an amount of about 0.1% to about 5% of the total weight of the dielectric composition. A suitable talc is commercially available from Luzenac America, Inc. located in Englewood, Colo.

The dielectric composition of the present invention may optionally include other additives. Such additives include for example, pigments, flow promoting agents, adhesion promotes, and mixtures thereof. Pigments are added for aesthetic purposes and to allow coatings from the dielectric composition to be readily seen. Virtually any pigment may be used. A particularly useful pigment is PC9119 Violet commercially available from Elementis located in East St. Louis, Ill. The pigment is preferably present in an amount from about 0.0 to about 10% of the total weight of the dielectric composition. More preferably, the pigment is present in an amount from about 0.0 to about 5% of the total weight of the dielectric composition; and most preferably, the pigment is present in an amount of about 1% of the total weight of the dielectric composition.

The dielectric composition of the present invention may also include a flow promoting agent. Preferably, the flow promoting agent in present in an amount of about 0.1% to about 10% of the total weight of the dielectric composition. More preferably, the flow promoting agent is present in an amount of about 0.1% to about 5% of the total weight of the dielectric composition; and most preferably, the flow promoting agent is present in an amount of about 2.5% of the total weight of the dielectric composition. Suitable flow promoting agents include Modaflow (an ethyl acrylate and 2-ethylhexyl acrylate copolymer), commercially available from Monsanto Chemical Co., St. Louis, Mo., and BYK-207 commercially available from BYK-Chemie located in Wallingford, Conneticut. Preferably, the dielectric composition of the present invention includes a mixture of Modaflow and BYK-207.

The following examples illustrate the various embodiments of the present invention. Those skilled in the art will recognize many variations that are within the spirit of the present invention and scope of the claims.

### EXAMPLE 1

This example provides a dielectric composition that may be applied to a substrate and photocured into a non-pigmented dielectric coating.

| | Approximate weight |
|---|---|
| Component | percent |
| Ebecryl 244 (acrylated | 29.6 |
| oligomer) | |
| Ebecryl 7100 (amine | 3.9 |
| functional acrylate co-initiator) | |
| Ethylene glycol dicyclopentyl | 17.2 |
| ether acrylate (acrylated | |
| monomer) | |
| Isobornyl Acrylate (“IBOA”) | 17.3 |
| (acrylated monomer) | |
| Iragure 500 (photoinitiator) | 1.6 |
| Iragure 2020 (photoinitiator) | 1.6 |
| Modaflow (flow promoting | 1.8 |
| agent) | |
| BYK-207 (flow promoting | 0.5 |
| agent) | |
| MIPP620XXF (wax) | 21.4 |
| CN132 (acrylated oligomer) | 5.1 |
| Total | 100.0 |

The IBOA, the EGDPE, the Iragure 500, and the Iragure 2020 are loaded in a mixing vessel and then mixed with a prop blade mixer at 1000 rpm until uniform. Next, the CN132, the Ebecryl7100, the EB244, and the Modaflow are loaded into the mixing vessel and then mixed until uniform. The MMP620XXF is then slowly added to the mixing vesselvortex at 1000 rpm until uniform. Finally, the BYK 207 is added and mixed until uniform.

### EXAMPLE 2

This example provides a dielectric composition that may be applied to a substrate and photocured into a pigmented dielectric coating.

| | Approximate weight |
|---|---|
| Component | percent |
| Composition of Example 2 | 99 |
| 50/50 preblend of IBOA and | 3.9 |
| PC9119 | |
| Total | 100.0 |

The composition of Example 2 is may by the same method described about for Example 1. After the BYK 207 is blended into the dielectric composition, a 50-50 (by weight) preblend of IBOA and PC9119 is mixed in at 1000 rpm until the dielectric composition is substantially uniform.

### EXAMPLE 3

This example provides a dielectric composition that may be applied to a substrate and photocured into a pigmented dielectric coating.

| | Approximate weight |
|---|---|
| Component | percent |
| Ebecryl 244 (acrylated | 30.0 |
| oligomer) | |
| Ebecryl 7100 (amine | 4.0 |
| functional acrylate co-initiator) | |
| Ethylene glycol dicyclopentyl | 17.0 |
| ether acrylate (acrylated | |
| monomer) | |
| Isobornyl Acrylate (“IBOA”) | 17.0 |
| (acrylated monomer) | |
| Iragure 500 (photoinitiator) | 1.5 |
| Iragure 2020 (photoinitiator) | 1.5 |
| Modaflow (flow agent) | 2.0 |
| BYK-207 (flow agent) | 0.5 |
| MIPP620XXF (wax) | 4.5 |
| CN132 (acrylated oligomer) | 5.0 |
| Talc | 15.0 |
| 50/50 preblend of IBOA and | 2.0 |
| PC9119 (pigment composition | |
| Total | 100.0 |

This composition is made in a manner similar to Example 2 with the talc being added with the wax.

Method for Depositing a UV Curable Dielectric Composition

In accordance with still another aspect of the invention, a method is provided for depositing a dielectric coating on a suitable substrate. The method comprises a first step of applying the dielectric compositions set forth above to the substrate. Dielectric coatings made from the compositions of the invention typically exhibit a dielectric strength greater than 2000 volts for a 1 mil thick coating as measured by the Hi-Pot test.

The dielectric composition may be applied to the substrate using a number of different techniques. The dielectric composition may be applied, for example, by direct brush application, or it may be sprayed onto the substrate surface. It also may be applied using a screen printing technique. In such screen printing technique, a “screen” as the term is used in the screen printing industry is used to regulate the flow of liquid composition onto the substrate surface. The dielectric composition typically would be applied to the screen as the latter contacts the substrate. The dielectric composition flows through the silk screen to the substrate, whereupon it adheres to the substrate at the desired film thickness. Screen printing techniques suitable for this purpose include known techniques, but wherein the process is adjusted in ways known to persons of ordinary skill in the art to accommodate the viscosity, flowability, and other properties of the liquid-phase composition, the substrate and its surface properties, etc. Flexographic techniques, for example, using pinch rollers to contact the dielectric composition with a rolling substrate, also may be used.

The method includes a second step of illuminating the dielectric fluid-phase composition on the substrate with a source of actinic radiation to cause the dielectric fluid-phase composition to cure into the dielectric coating. The preferred source is a ultraviolet light source. This illumination may be carried out in any number of ways, provided the ultraviolet light or radiation impinges upon the dielectric composition so that the dielectric composition is caused to polymerize to form the coating, layer, film, etc., and thereby cures. Curing presumably takes place by free radical polymerization, which is initiated by an ultraviolet radiation source. The photoinitiator preferably comprises a photoinitiator, as described above. Various ultraviolet light sources may be used, depending on the application. Preferred ultraviolet radiation sources for a number of applications include known ultraviolet lighting equipment with energy intensity settings of, for example, 125 watts, 200 watts, and 300 watts per square inch.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A photocurable composition for forming a dielectric layer on a substrate, the photocurable composition comprising:
a first acrylated oligomer;
a second acrylated oligomer having a viscosity less than the first;
a wax;
an acrylated monomer; and
a photoinitiator.

2. The photocurable composition of claim 1 wherein the first acrylated oligomer comprises a component selected from the group consisting of an acrylated epoxy oligomer, an acrylated polyester oligomer, acrylated silicone oligomer, acrylated acrylic oligomer, acrylated urethane oligomer, an acrylated melamine oligomer, and mixtures thereof.

3. The photocurable composition of claim 1 wherein the first acrylated oligomer comprises aliphatic urethane acrylate.

4. The photocurable composition of claim 3 wherein the aliphatic urethane acrylate comprises a component selected from the group consisting of aliphatic urethane monoacrylates, aliphatic urethane diacrylates, aliphatic urethane triacrylates, and mixtures thereof.

5. The photocurable composition of claim 1 wherein the second acrylated oligomer comprises a component selected from the group consisting of an acrylated epoxy oligomer, an acrylated polyester oligomer, acrylated silicone oligomer, acrylated acrylic oligomer, acrylated urethane oligomer, an acrylated melamine oligomer, and mixtures thereof.

6. The photocurable composition of claim 1 wherein the second acrylated oligomer comprises a component selected from the group consisting of an aliphatic monoacrylates oligomer, aliphatic diacrylate oligomer, an aliphatic triacrylate oligomer, and mixtures thereof.

7. The photocurable composition of claim 1 wherein the acrylated monomer comprises a component having formula I: 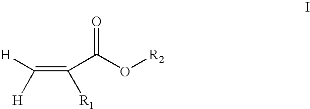
wherein R₁ is hydrogen or substituted or unsubstituted alkyl; and R₂ is substituted or unsubstituted alkyl having more than 4 carbon atoms, a cycloalkyl, a cycloalkenyl, or a substituted or unsubstituted aryl.

8. The photocurable composition of claim 7 wherein R₁ is hydrogen or methyl; and R₂ is isoborynl, phenyl, benzyl, dicylcopentenyl, dicyclopentenyl oxyethyl, ethylene glycol dicyclopentyl ether, cyclohexyl, and naphthyl.

9. The photocurable composition of claim 4 wherein the acrylated monomer comprises a component selected from ethylene glycol dicyclopentyl ether acrylate, an isobornyl acrylate, and mixtures thereof.

10. The photocurable composition of claim 1 wherein the wax comprises a micronized wax.

11. The photocurable composition of claim 1 wherein the wax comprises a polyolefin wax.

12. The photocurable composition of claim 1 further comprising a talc.

13. The photocurable composition of claim 1 wherein:
the first acrylated oligomer is present in an amount from about 5 weight percent to about 80 weight percent;
the second acrylated oligomer is present in an amount from about 1 weight percent to about 30 weight percent;
the wax is present in an amount from 1 weight percent to about 60 weight percent;
the acrylated monomer is present in an amount from about 5 weight percent to about 80 weight percent; and
the photoinitiator is present in an amount from about 0.1 weight percent to about 20 weight percent.

14. The photocurable composition of claim 1 further comprising an amine functional acrylate co-initiator.

15. The photocurable composition of claim 1 further comprising a component selected from a pigment, a flow promoting agent, and mixtures thereof.

16. A photocurable composition for forming a dielectric layer on a substrate, the photocurable composition comprising:
an aliphatic urethane acrylate;
an acrylated oligomer having a viscosity less than the aliphatic urethane acrylate;
a polyolefin wax;
an acrylated monomer; and
a photoinitiator.

17. The photocurable composition of claim 16 wherein the aliphatic urethane acrylate comprises a component selected from the group consisting of aliphatic urethane monoacrylates, aliphatic urethane diacrylates, aliphatic urethane triacrylates, and mixtures thereof.

18. The photocurable composition of claim 16 wherein the acrylated oligomer having a viscosity less than the aliphatic urethane acrylate comprises a component selected from the group consisting of an acrylated epoxy oligomer, an acrylated polyester oligomer, acrylated silicone oligomer, acrylated acrylic oligomer, acrylated urethane oligomer, an acrylated melamine oligomer, and mixtures thereof.

19. The photocurable composition of claim 16 wherein the acrylated oligomer having a viscosity less than the aliphatic urethane acrylate comprises a component selected from the group consisting of an aliphatic monoacrylates oligomer, aliphatic diacrylate oligomer, an aliphatic triacrylate oligomer, and mixtures thereof.

20. The photocurable composition of claim 16 wherein the acrylated monomer comprises a component having formula I: 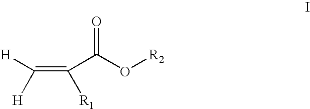
wherein R₁ is hydrogen or substituted or unsubstituted alkyl; and R₂ is substituted or unsubstituted alkyl having more than 4 carbon atoms, a cycloalkyl, a cycloalkenyl, or a substituted or unsubstituted aryl.

21. The photocurable composition of claim 20 wherein R₁ is hydrogen or methyl; and R₂ is isoborynl, phenyl, benzyl, dicylcopentenyl, dicyclopentenyl oxyethyl, ethylene glycol dicyclopentyl ether, cyclohexyl, and naphthyl.

22. The photocurable composition of claim 16 wherein the acrylated monomer comprises a component selected from ethylene glycol dicyclopentyl ether acrylate, an isobornyl acrylate, and mixtures thereof.

23. The photocurable composition of claim 16 wherein the polyolefin wax comprises a micronized polyolefin wax.

24. The photocurable composition of claim 16 wherein the polyolefin wax comprises a wax selected from the group consisting of polyethylene, polypropylene, and mixtures thereof.

25. The photocurable composition of claim 16 wherein:
the aliphatic urethane oligomer is present in an amount from about 5 weight percent to about 80 weight percent;
the acrylated oligomer is present in an amount from about 1 weight percent to about 30 weight percent;
the polyolefin wax is present in an amount from 1 weight percent to about 60 weight percent;
the acrylated monomer is present in an amount from about 5 weight percent to about 80 weight percent; and
the photoinitiator is present in an amount from about 0.1 weight percent to about 20 weight percent.

26. The photocurable composition of claim 16 further comprising an amine functional acrylate co-initiator.

27. The photocurable composition of claim 16 further comprising a component selected from a pigment, a flow promoting agent, and mixtures thereof.

28. A photocurable composition for forming a dielectric layer on a substrate, the photocurable composition comprising:
an aliphatic urethane acrylate;
an acrylated oligomer having a viscosity less than the aliphatic urethane acrylate;
a polyolefin wax;
an isobornyl acrylate;
an ethylene glycol dicyclopentyl ether acrylate;
amine functional acrylate co-initiator; and
a photoinitiator.

29. The photocurable composition of claim 27 wherein:
the aliphatic urethane oligomer is present in an amount from about 5 weight percent to about 80 weight percent;
the acrylated oligomer is present in an amount from about 1 weight percent to about 30 weight percent;
the wax is present in an amount from 1 weight percent to about 60 weight percent;
the isobornyl acrylate is present in an amount from about 5 weight percent to about 80 weight percent;
the an ethylene glycol dicyclopentyl ether acrylate is present in an amount from about 5 weight percent to about 80 weight percent;
the amine functional acrylate co-initiator is present in an amount from about 1 weight percent to about 10 weight percent;
a talc present in an amount from about 0.1 weight percent to about 25 weight percent; and
the photoinitiator is present in an amount from about 0.1 weight percent to about 20 weight percent.

30. The photocurable composition of claim 27 further comprising a pigment and a flow promoting agent.
